(19) United States
(12) Patent Application Publication
(10) Pub. No.: US 2004/0234844 A1
(43) Pub. Date: Nov. 25, 2004

(54) Novel carbon nanotube lithium battery

(75) Inventors: Robert Scott Morris, Fairhaven, MA (US); Brian Gilbert Dixon, Sandwich, MA (US)

Correspondence Address: PERKINS, SMITH & COHEN LLP, ONE BEACON STREET, 30TH FLOOR, BOSTON, MA, 02108, US

(73) Assignee: Phoenix Innovation, Inc., West Wareham, MA

(21) Appl. No.: 10/668,976

(22) Filed: Sep. 23, 2003

Related U.S. Application Data
(60) Provisional application No. 60/471,780, filed on May 20, 2003.

(51) Int. Cl. H01M 6/00

(52) U.S. Cl. 429/122

(57) ABSTRACT

This Simplified Self Powered Attitude Survival Indicator, provides a simple indicator which gives a visual indication of aircraft attitude and provides suitable indicators and alarms when needed. No vacuum or powered gyroscopes are used. The indicator is self powered and readily transportable from one aircraft to another. This invention is not used to replace the standard gyroscopic indicator, but to supplement it.

### TECHNICAL FIELD

This self-powered invention relates to non-gyroscopic attitude indicators for use in personal or general aircraft, and which may also be used in Ultra-Light, or home-brew aircraft.

### BACKGROUND ART

Many devices have been developed to alert the pilot of an aircraft of changes in his attitude. These devices depend upon a gyroscopic device and resultant mechanical display of the horizon or attitude.

Gyroscopic devices are usually powered by air flow, vacuum, or electric motors. Failure of any of these power sources can render the gyroscopic attitude indicator inoperative. The gyroscopic attitude indicator described above, is generally very accurate, and is considered to be reliable and easy to understand. Although the gyroscopic indicator has been simplified over the passing years, it takes practice to understand the gyroscopic indicator and interpret the significance of the display.

What is needed is a simple, though less accurate, indicator which gives a visual indication of aircraft attitude and provides suitable alarms when needed. This invention is not designed to replace the gyroscopic indicator, but to supplement it.

The present invention fulfills those requirements and in addition is self-powered and self contained, and the survival attitude indicator can be transferred between different aircrafts without complicated electrical or mechanical attachments to the engines or the aircrafts.

### PRIOR ART

Desired rate of turn indicator. U.S. Pat. No. 6,489,898 By Nichols, Issued Dec. 3, 2002, Assigned to Honeywell International, Morristown, N.J.

### DISCLOSURE OF THE INVENTION

The invention, called a Simplified Self Powered Attitude Survival Indicator, consists of an enclosure, (A) which may be manufactured of plastic or metal, an internal or external power source, a plurality of internal attitude sensors, a plurality of piezoelectric alarms, a plurality of small aircraft bulbs or LED (Light Emitting Diodes) indicators, a power switch, [SW-1] and a variety of Velcro™ fastening devices for easy attachment and removal from the aircraft, said indicator is usually placed in the field of view of the pilot. The internal attitude sensors may be switches, LVDT's potentiometers, mercury switches, or a combination of these elements, working together by means of electronic logic. Since there is no active oscillators, the instrument described does not produce electromagnetic interference.

### BEST MODE FOR CARRYING OUT THE INVENTION

Indicators and Operation

Referring to FIG. 1, which illustrates the many indicator LED's that are used. When power is applied by the operation of SW1. The GREEN indicators (i14, i23, i1, i2, and i7) are illuminated. i2 and i7 represent a display of the reference attitude and i22 shows that the power is applied, but is of low voltage and it is time to replace the internal batteries, or apply external power through J1, J2, and/or J3. When the aircraft is flying straight and level, a plurality of GREEN indicators (i3, i4,i1, i5, i6 and i7), illustrated in FIG. 1 and are presented as a full horizontal line. As the aircraft banks to the right, (i8, i9, i1, i11, i12, and i13) RED indicators are illuminated. This is illustrated in FIG. 6. As the aircraft makes a left bank, the previous indicators shut down and the RED indicators (i15, i16mi7, i18, i19 and i20) are illuminated. This is illustrated in FIG. 5. As the aircraft climbs, the BLUE indicators (i24 and i26) are illuminated. When descending, YELLOW indicators (i25 and i27) are illuminated. In addition, all indicators are mounted within it's own display tube (18) which may be plastic, or metal, and in which the interior surface is painted flat black, chromed, or left as natural aluminum. This tubular member is used to enhance contrast and visibility of the LED or low voltage, low current (grain of wheat) incandescent lamps, hereafter simply called “incandescent lamps” (22) in high ambient light conditions. The tube assembly is shown in FIGS. 8 and 9.

The tubular member is pressed into an interference fit bore in the invention housing. A large Amber flasher (i4) indicator and audible alarm (i21) shown in FIG. 7, reveals when the aircraft is inverted, upside-down, or in a stall condition. Blue Indicators (i5 and i7) indicate when the aircraft is in a climbing attitude (nose up greater than 10 degrees). RED Flashing or YELLOW indicators (i5), illustrated in FIG. 5, will be used to indicate a nose down greater than 10 degrees. These indicators can be used as an assist in landing the aircraft.

An upside down condition often cannot be discerned by the pilot, especially when he is flying in a thick fog or in the dark of night. The indicator may save the pilot's life.

When the aircraft executes a LEFT BANK, and exceeds 30 degrees, a bank of RED indicators on the front panel (indicators i5,i6,i7,i8,i9, and i20) illuminate, generating a line of indicators which present a straight line at about 45 degrees, slanted to illustrate a left bank condition. This condition is shown in FIG. 5.

When the aircraft executes a RIGHT BANK, and exceeds 30 degrees, a bank of RED indicators on the front panel illuminate, generating a line of indicators (Indicators, i13,i12,i11,i10, i9 and i,8.) which present a straight line at about 45 degrees, slanted to illustrate a right bank condition. This condition is illustrated in FIG. 6.

For either a right or left bank, when the bank reaches or exceeds 10 degrees, and is less than 30 degrees, the bank indicators may change color or flash, alerting the pilot that he is executing a bank. At 30 degrees, the flashing or color will revert to steady RED.

For either a left bank, or a right bank, when the bank reaches approximately 40 degrees a warbling or pulsating audible alarm (10) sounds, telling the pilot that his bank is becoming excessive and this is a dangerous condition. One limitation of this device is that the bank indicators can be confusing. Since the indicator lights are physically fixed at 45 degrees on the front panel, these indicators do not display the actual bank. That is solved by illuminating these lights at 30 degrees. However, it is important for the pilot to know when he is entering a banked condition. The sensor is equipped to provide an output when either the right or left bank is ten degrees. This output can initiate flashing of either the right or left bank indicators. Alternatively a LED with a dual color output can be employed. For example, the 45 degree line of indicators can be YELLOW/GREEN at ten degrees, and convert to RED when the left or right bank is 30 degrees or more.

When the aircraft is flying level, the green reference (indicators i2,i7,i23, and i4) mentioned above, remain illuminated, but when the nose is pitched up by approximately 30 degrees, the blue indicators i26 and 24 flash and a warbling alarm (10) sounds to indicate the possibility of a stall condition. FIG. 6 illustrates the BLUE indicators.

If the nose is pointing down by more than 20 degrees, YELLOW indicators (i25 and i27) illuminate to reveal a nose-down condition. If the nose-down condition exceeds 30 degrees. There is a warbling sound and amber indicator (10) flashes.

Other indicators include an amber or yellow indicator which tells the pilot that the internal batteries are low. “LOW BATT.” (i22), seen in FIG. 7. This indicator may flash to get the pilot's attention.

Power is supplied by four AA carbon-zinc batteries, or four AA alkaline rechargeable batteries. Batteries may be double “AA”, “A”, C”, OR “D”. Provision is also made to accommodate four Nickle Cadmium batteries if desired. In this case, the device shall include a small constant current charger, deriving power from the aircraft power supply (usually 14 or 28 volts). The instant invention may be modified for 48 volt external operation by removing an internal jumper, or directly by applying an external 12, 24, or 6 volt power supply through jacks provided for this purpose.

FIGS. 8 and 9 illustrate the detail of the tubes designed to eliminate the effect of high ambient light on the Simplified Self Powered Survival Attitude Indicator of the present invention, a plastic or metal tube assembly or shield (18) is machined to contain a mounting shoulder (19) which is sized to provide an interfering ring which is press fitted into a panel bore (20) which is part of the housing of the present invention. A incandescent bulb or LED (22) is mounted within the housing. Electrical connections to the illuminating device (22) are shown as item (23).

It is understood that where a LED is described, the indicator may also be an incandescent “grain of wheat” aircraft bulb. LED's are mentioned for clarity or brevity. When an incandescent lamp is used, the current limiting resistors (470 Ohms) are not required.

Instead of the individual light-blocking tubes, the front panel may be made of a heavy aluminum or plastic blank. Typically, this blank may be 0.25 to 0.375 inches thick, and individual tubes not be used,

The present invention can be mounted on a section of panel. A velcro pad provides attachment and some vibration protection.

Although this invention has been shown and described with respect to detailed embodiments thereof, it will be appreciated and understood by those skilled in the art that various changes in form and detail thereof, may be made without departing from the spirit and scope of the claimed invention.

Identification of the indicators is as follows: These may be incandescent or LED's

| SYMBOL | COLOR | INDICATES |
|---|---|---|
| i1 | GREEN | Power ON |
| i2 and i7 | GREEN | Horizontal Reference Indicators |
| i8-i13 | RED | Right Bank, green or flashing if 10 |
| | | degrees |
| i14-i23 | GREEN | Rudder |
| i15-i20 | RED | Left Bank, green or flashing if 10 |
| | | degrees |
| i21 | LARGE AMBER | Alarm Light |
| | | A) Stall with sound, flashing |
| | | B) Excessive bank. Right bank or Left |
| | | bank |
| i22 | RED or AMBER | Low Battery-flashing , and audio alarm |
| i24 | BLUE | Right Climbing Indicator |
| i25 | AMBER | Right Descending indicator |
| i26 | BLUE | Left Climbing indicator. |
| i27 | AMBER | Left Descending indicator |

Note that although LED's are the preferred devices because of their low operating voltages, low current requirements, high shock and vibration tolerance, and color, there are certain types of incandescent grain of wheat lamps which have low power requirements, and are capable of high shock and vibration. These lamps may be used, but the 470 ohm series current limiting resistors may be changed accordingly.

### OBJECTS OF THE INVENTION

Often, the standard gyroscopic attitude indicator, found in virtually all aircraft, can fail mechanically, or the vacuum system of the aircraft may fail, or otherwise there may not be an indication of the attitude changes quickly enough so that the pilot can rapidly discern the true attitude of his aircraft. Under certain conditions, not knowing the aircraft attitude may lead to a dangerous condition or a fatal crash.

The simplified attitude indicator, described herein, does not depend upon the aircraft vacuum system, or the aircraft power system. For normal operation, the instrument is completely self-contained and may readily be transferred from aircraft to aircraft.

The object of this invention is to provide indication of the aircraft attitude simply by means of reliable LED or aircraft incandescent indicators, The attitude indicator is powered by self-contained batteries. A low battery level indicator alerts the operator when time to replace the batteries is approaching. In addition, the system may use batteries of the size, AA, A, C, or D. Alternatively, external battery power of 6,12, 24, or 48 volts may be used. Rechargeable batteries may also be used in this instrument.

With LED Indicators:

AA batteries expected operating time is approximately 22 continuous hours,

C size batteries, operating life is approximately 40 continuous hours,

D size batteries, operating life on a set of batteries is 80 continuous hours.

### EXPLANATION OF FIGURES

FIGS. 1 through 7 explain the different conditions of flight that the front panel may display.

FIG. 1 identifies the location of the different indicators, they are not numbered sequentially.

Indicators i1, i23 and i14 represent normal position of the rudder. This display is static when the aircraft changes attitude.

Indicators i2 and i7 are horizontal references, they are fixed.

Indicators i3, i4, i5, and i6 indicate that the aircraft is flying level.

The right banking indicators are numbered, i8, i9, i10, i11, i12, and i13.

These same numbers are indicated on the main schematic diagram. Item 21 is an audible alarm which sounds when the stall light i21 is illuminated. This alarm may be a magnetic speaker or a piezoelectric “buzzer or beeper”. This audible alarm is also energized if the aircraft has inverted in flight.

Item 21 is a a bright incandescent illuminator or oversize LED, which is operated when a stall or inverted condition exists.

If the 6 volt power buss falls below 5 volts, the low battery indicator i22 is illuminated. The system is fully functional as low as 4.2 volts, allowing sufficient operating time to replace the batteries.

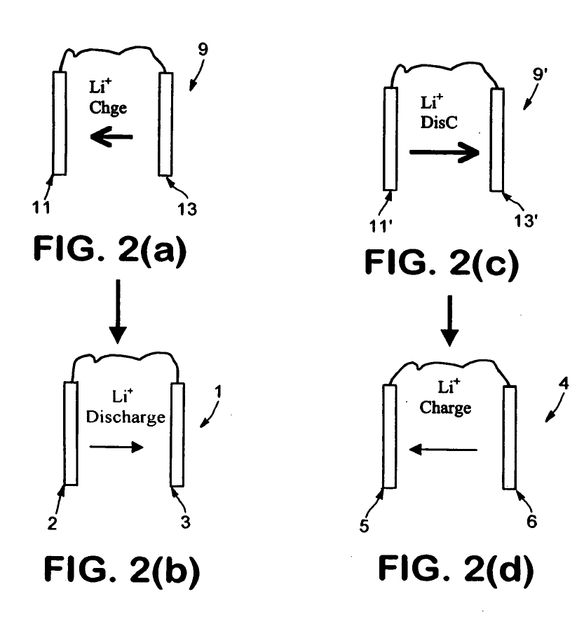

FIG. 2 illustrates the aircraft indicators when the flight is level and ascending. Indicators i23 and i5 represent the vertical stabilizer, and indicators i2, i3, i4, i5, i6, and i7 represent the wing plane when the aircraft is in level flight. In this drawing, indicator i22 has been illuminated to show a low battery condition. Low voltage is defined as 5 volts (1.5 volts per cell). The circuits will operate to 4.2 volts (1.05 volts per cell). This will allow sufficient time for operation to allow batteries to be replaced.

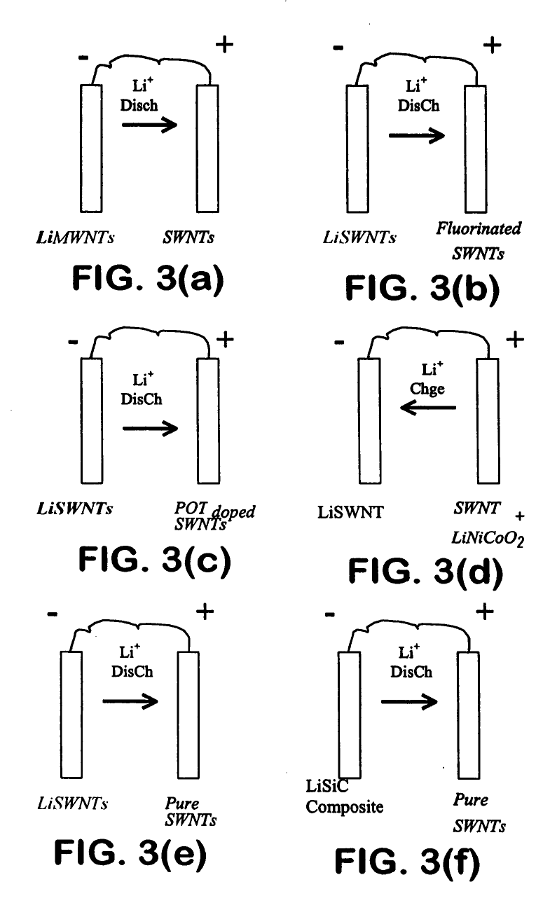

FIG. 3 illustrates the aircraft in a level flight nose down attitude.

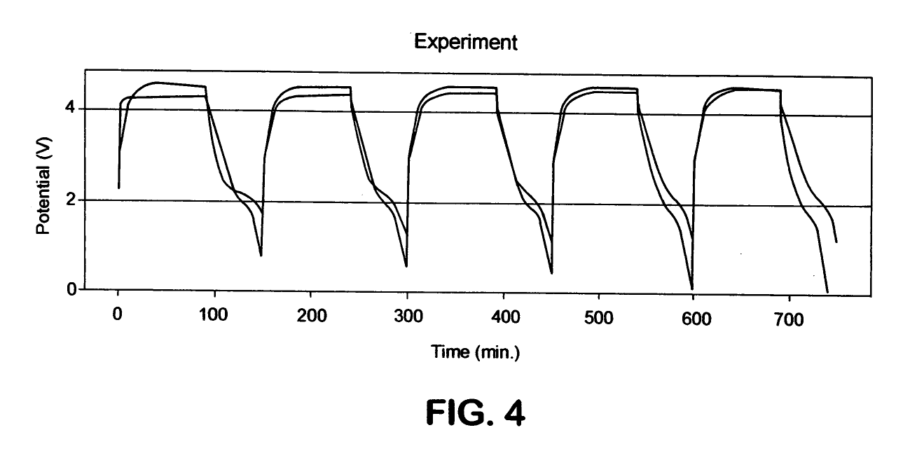

FIG. 4 illustrates the aircraft in a right bank attitude.

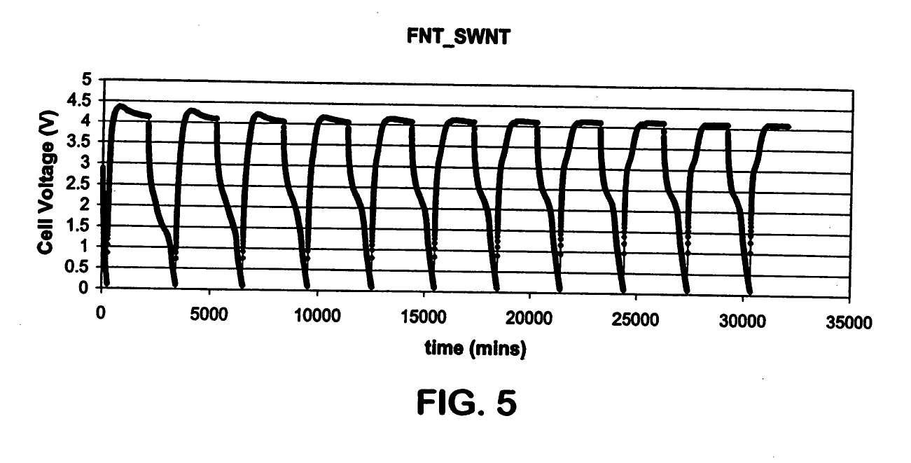

FIG. 5 illustrates the aircraft in a left bank attitude.

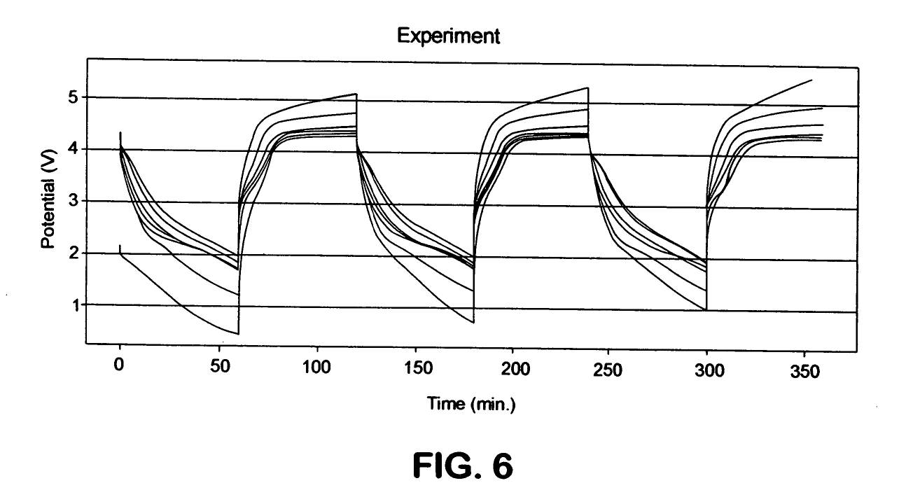

FIG. 6 illustrates the aircraft in a right bank ascending attitude.

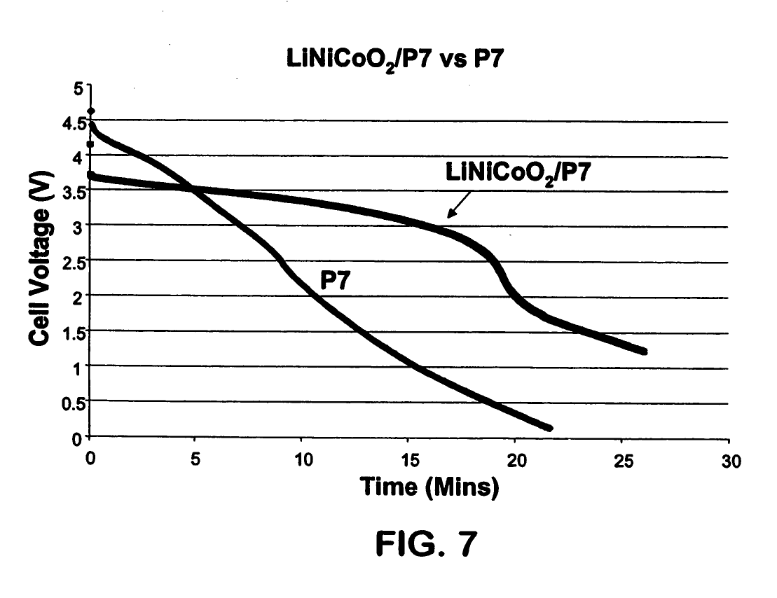

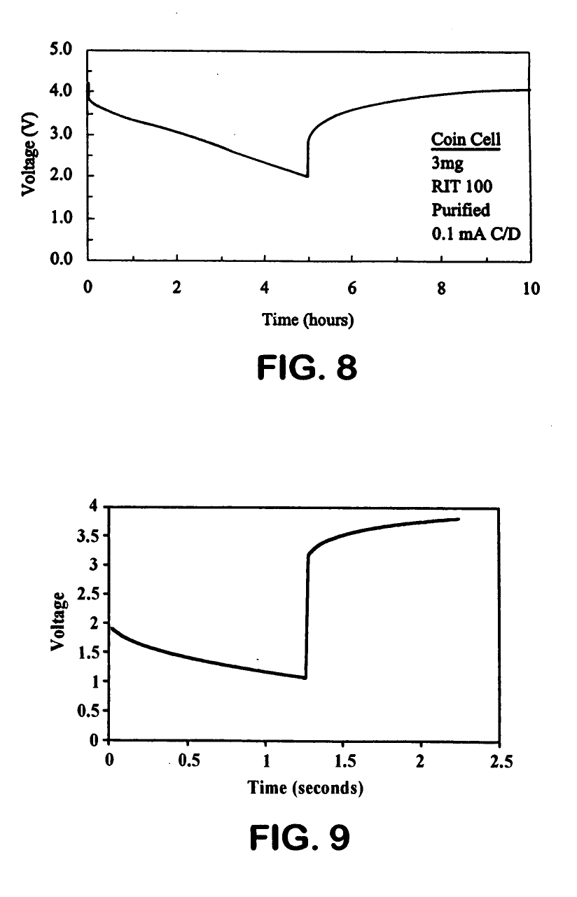

FIG. 7 illustrates the low battery indicator.

FIG. 8 represents a left bank, descending. The Low battery condition is also shown.

FIG. 9 is a typical LED mounted in an anti glare accessory.

FIG. 10 is the functional schematic of the simplified self powered attitude survival indicator

FIG. 11 is the schematic of the pulse generator for operating the indicators between 10 and 30 degrees. If the 555 chip is used, then two separate identical circuits are used. A 556 chip may be used for both circuits.

An object of this invention is to get the aircraft into VFR conditions rapidly and safely. Alarms for improper flight are functionally provided.

The foregoing and other features of the present invention will become more apparent from the following description and accompanying drawings.

### BRIEF DESCRIPTION OF THE DRAWINGS

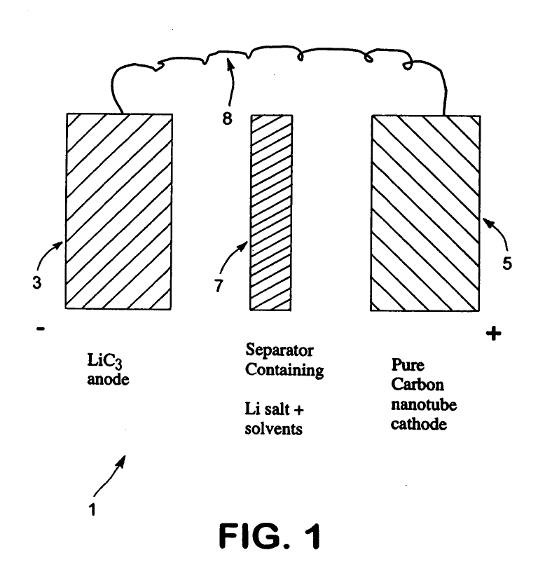

FIG. 1 illustrates the overall size and appearance of the front panel, including the displays which have been described herein. The invention is called a Simplified Self Powered Survival Attitude Indicator.

FIG. 2 illustrates the indicator LED's or incandescent lamps when the aircraft is flying in level flight and ascending.

FIG. 3 illustrates the indicators for level flight, nose down.

FIG. 4 illustrates the indicator LED's when the aircraft is flying in a right bank flight that is greater than 20 to 30 degrees. The actual angle is dependent upon the aircraft type and design, and the angle is internally adjustable. These indicators flash at approximately ten degrees of bank.

FIG. 5 illustrates the indicator LED's when the aircraft is flying in a left bank flight that is greater than 20 to 30 degrees. These indicators flash at approximately ten degrees of bank, and the angle is internally adjustable.

FIG. 6 illustrates the indicator LED's when the aircraft is flying in a right bank, nose up attitude that is greater than 20 to 30 degrees. The actual angle is dependent upon the aircraft type and design, and is internally adjustable by the manufacturer Note that when LED's are indicated, the product may use either LED's or incandescent lamps.

FIG. 7 indicates the low battery display.

FIG. 8 illustrates the indicator LED's when the aircraft is banking left, nose down, with a low battery also indicated.

FIG. 9 illustrates the LED mounted in an individual light shield.

FIG. 10 illustrates the schematic diagram of the Simplified Self Powered Survival Attitude Indicator described herein.

FIG. 11 is the diagram of the flasher power circuit, Although the prototype uses two 555 generator circuits, a single 556 IC may be used.

1. We claim a Simplified Self Powered Attitude Survival Indicator which is self powered and can readily be transferred from one aircraft to another and which provides all of the essential functions that are usually supplied by vacuum powered gyroscopic attitude indicators, said indicators providing information relating to level flight, left bank, right bank, ascending flight, descending flight, craft inversion, stall, low battery, and audio alarms.

2. The Simplified Self Powered Attitude Survival Indicator of claim 1, where the power units are self contained containing dry or rechargeable batteries, said batteries being comprised of four carbon-zinc or alkaline cells, of the size, “AA”, “A”, “C”, “D”, said batteries being series connected to provide six volts of power.

3. The Simplified Self Powered Attitude Survival Indicator of claim 1 where the indicators consist of a plurality of colored LED lamps or aircraft type incandescent lamps.

4. The Simplified Self Powered Attitude Survival Indicator of claim 3, where said LED's are for aircraft banking, indicators can be wired to flash or change color between 10 degrees and 30 degrees, and then display a solid color when the flight angle exceeds 30 degrees from level flight.

5. The Simplified Self Powered Attitude Survival Indicator of claim 3, where said LED's for aircraft banking, ascending and descending indicators can be wired to flash or change color between 10 degrees and 20 degrees from level flight, and then display a solid color when the flight angle exceeds 20 degrees.

6. The simplified self powered attitude survival indicator of claim 5 wherein incandescent lamps are used, coloring may be achieved by adding cellophane or doping the lamp glass surface as required,

7. The Simplified Self Powered Attitude Survival Indicator of claim 3, where said LED's for level flight are extinguished when either left banking or right banking are detected.

8. The Simplified Self Powered Attitude Survival Indicator of claim 3, where an incandescent or large LED and an audio alarm are activated when the aircraft is subject to stall conditions.

9. The Simplified Self Powered Attitude Survival Indicator of claim 1, where external voltage inputs of 6, 12, 24, and 48 volts may be applied to accommodate different aircraft voltages, said voltage being available from a local “cigarette lighter” convenience jack.
